(19) United States
(12) Patent Application Publication
(10) Pub. No.: US 2014/0280348 A1
(43) Pub. Date: Sep. 18, 2014

(54) EDUCATIONAL LIBRARY SYSTEM

(71) Applicant: Benjamin R. Conn, Wildwood, MO (US)

(72) Inventor: Benjamin R. Conn, Wildwood, MO (US)

(21) Appl. No.: 13/843,084

(22) Filed: Mar. 15, 2013

(51) Int. Cl. G06F 17/30

(52) U.S. Cl. CPC G06F 17/30289
USPC 707/783

(57) ABSTRACT

Methods, systems and computer readable media for educational library management are described.

### TECHNICAL FIELD

Embodiments relate generally to library management systems, and more particularly, to methods, systems and computer readable media for management of educational libraries, such as classroom libraries.

### SUMMARY

Some implementations can include a personalized checkout system for a teacher's classroom library. Some implementations can also include a reference to identify the various reading levels assigned to a given book by an assortment of leveling systems. Leveling can include the classification of a book (or other media) to a particular reading level (or ability). Some implementations can be used across a variety of platforms including, but not limited to, remote wireless platforms such as those provided for smart phones and tablet computers, on-line as an account through a website, and as a stand-alone program installed on a local computer, or a combination of the above.

In addition to physical books, it will be appreciated that the education library system and method described herein can be used with electronic books (or ebooks), movies, videos, audio files and any other now known or later developed media formats.

Some implementations include building a database of books, identified by their ISBNs and related barcodes. The database can include general bibliographic information, reading level assignments, cover images, and pricing information. The database can be accessible through the educational library management system, which can perform searches based on various criteria maintained in the database. The system may emphasize use of the ISBN and its related barcode, which provides a barcode reading interface for user or “librarians” to scan as a more convenient option to typing out a 13 digit number, or non-standardized title.

With access to the database, users can retrieve general information about a book from a variety of resources and also establish foundations of their own personal libraries. Through an authenticated (e.g., username/password) account system, users can identify which specific books (and how many copies) are contained on the shelves. In addition to the books, users can also build a roster of members (e.g., students, colleagues or the like) in their libraries. Some implementations can include a check-in/check-out system configured to associate a given title with a given member when the member checks-out the title.

### BRIEF DESCRIPTION OF THE DRAWINGS

FIG. 1 is a diagram of an example educational library system in accordance with at least one embodiment.

FIG. 2 is a flowchart of an example method for educational library management in accordance with at least one embodiment.

FIG. 3 is a diagram of an example computer system for educational library management in accordance with at least one embodiment.

FIG. 4 is a diagram of an example book record in accordance with at least one embodiment.

FIG. 5 is a diagram of an example member record in accordance with at least one embodiment.

FIG. 6 is a diagram of an example leveling translation system in accordance with at least one embodiment.

FIG. 7 is an example method for leveling and labeling a book in accordance with at least one embodiment.

### DETAILED DESCRIPTION

FIG. 1 is a diagram of an example educational library management environment 100. The environment 100 includes an educational library management system 102 that is configured to interact with a variety of user devices and/or systems such as mobile devices 104, a web browser interface 106 and a standalone computer application program 108.

In operation, the system 102 receives book information from one or more bibliographic information sources 110 and from one or more leveling information sources 112. The book bibliographic and leveling information can be stored in a book database 114.

The system 102 enables users to create one or more libraries including one or more books that are available in an educational library. The system 102 also enables users to add one or more groups of members. The users (or “librarians”) can be librarians, teachers or other educators that have a collection of books (e.g., a library) that they wish to lend to one or more members (e.g., students). The library and member information can be stored in one or more library and/or member databases 116.

To help facilitate the check out and check in of books and/or to present leveling information, the system 102 can send a unique ID number (e.g., an ISBN, EAN or other ID bar code) to a printer 116 for a label to be printed. The printed can be connected to the system 102 or can be a printer connected to or in communication with one of the user systems (e.g., 104-108). The printer 118 can be wired or wireless.

The system can be configured to receive and compile bibliography and literacy leveling information from various resources and put that information in one database unlike conventional systems that may not have this information readily available in a single location or in a single system. The system can gather “formal” leveling data from authoritative literacy focused institutions as well as publishers. The system 102 can access and provide a conversion-type tool that will take the input of one leveling system and translate it to the equivalent value of another, different leveling system as shown below in FIG. 6 and described below.

In addition, some of books on a bookshelf have become out of print or unavailable. The system can build a book database having every ISBN for every title that we can find with leveling information. The features described above can provide an advantage in that the book database may be both larger and more informative than other book databases.

The system can include understanding and evaluating the similarities and differences between available leveling systems, and can include features based on a rotating curriculum for best practices in creating and maintaining a classroom (or educational) library.

The system 102 can include search features. For example, in a smart phone/wireless device implementation, the system software can make use of an available camera to capture an image of the book (e.g., of a barcode, text or the like) and convert the image into unique ID (e.g., in a manner similar to that of a barcode scanner). Barcode scanning can be a convenient and potentially more accurate alternative to manual entry of a 10- or 13-digit ISBN, or attempting a less reliable search by title, keyword, or author.

While barcode scanning may be a preferred input method, it will be appreciated that there are some instances where manual entry may be needed. The system 102 can assist a user in accurate data entry of an ISBN using built-in logic in the entry field so that the system can recognize the differences between the two formats and also determine if the data entered is a valid code. As a by-product of this verification and validation, the system can also display the conversion, back and forth, between 10- and 13-digit ISBNs.

The system can provide an additional mode of searching or adding books to a library using “mass scanning”, which would allow a user to scan barcodes quickly to a list or directly into the library without the extra step of reviewing the information for each book, one at a time.

In some implementations, throughout the search and retrieve process, there will be continual link availability to assist with finding different formats for the same titles; finding titles of similar theme, style, and/or level; and finding updated newer publications of editions out of print or unavailable. The system 102 can provide a wizard-type process for finding alternatives to books that a user can't find using other search methods.

The system 102 can also include a feature for permitting a user to communicate with a third party (e.g., the system developer) quickly and directly about books that the user was unable to find. The system 102 can also provide explanations of reading levels and extended links to documentation or discussion.

Some implementations can include functions to generate two types of labels for books: barcodes and leveling detail. The system can send label jobs to a wireless printer (e.g., 118) stocked with the appropriate size labels.

In addition to this capability, links can be provided to pages that offer detailed instructions for the printing process. A third party system can have access to the contents of libraries, and can be used to create customized labels of all of the books in a library without the need for the librarian to provide any more information than a request and a design.

For some users it may be more practical to maintain multiple libraries or multiple lists of classroom members. The system 102 will permit toggling between multiple libraries so that the libraries can be kept separate without having to continually log out of one and into another.

For some users, such as schools, it may be helpful to “network” or share libraries amongst different classrooms. Librarians can lend between their own libraries if certain books needed to be borrowed.

It is a major convenience for librarians to be able to create lists of books or students outside the confines of an application, whether for printing, manipulation or editing in another program. The system 102 can allow the user to export these lists.

In addition, when working with large lists, it can be easier to create lists of student information or book details in another program. The system 102 can also have a utility that will accept the import of this information into a library as well.

The system can also maintain a history of students' lending activity, and the travels of the books being lent can be stored. Librarians can have access to system generated reports such as a student's reading progress as a list of titles or a chart of reading levels achieved; an individual student's feedback on all of the books they've read; likes, dislikes, ease and/or difficulty; a compilation of student feedback for any given book; the most popular books; the most popular category, theme and/or style; the system can help to define where a given library may have gaps or deficiencies and can offer suggested supplements or fresh titles. The reports can be printed, saved and passed along to future teachers, or emailed to parents.

The educational library management system 102 can be configured to perform operations such as those described below in connection with FIG. 2, which shows a flow chart of an example educational library management method in accordance with at least one embodiment.

Referring to FIG. 2, processing begins at 202, where a book database is generated. The book database can include records having information such as that shown in FIG. 4 and described below. Also, the book database can include the information discussed above in connection with the book database 116 of FIG. 1. Processing continues to 204.

At 204, one or more librarian (or user) accounts are created. The user accounts can include biographical information and authentication information (e.g., username and password). Processing continues to 206.

At 206, one or more libraries are created. Each library can have one or more groups of one or more books. Each library is associated with at least one user (or librarian) responsible for maintaining that library. Books can be added to the libraries via manual entry (e.g., typing, gesture input, voice input or the like), automatic entry (e.g., barcode scanning or the like) or a combination of the two. Processing continues to 208.

At 208, one or more groups of members are added to the system. Processing continues to 210.

At 210, a book is checked-out by the system to a member. As part of the check-out, the book is associated with the member. For example, the system, can include a simple checking system through which a librarian can select a book—through barcode scanning or search—and check it out to one of the student members.

The system allows for the adjustment of the lending period as a default or for each individual check-out. It can identify books that are lent out with a flag and the name of the student who has the book checked out. Books that are checked-out past their allotted lending period will also be flagged as overdue. Books that become overdue will trigger an automated email reminder to be sent to a distribution list of addresses proscribed by the librarian. There is also an option to filter a list of only the books that are available, only the books that are checked-out, and only the books that are overdue—with a summary total of each category. Processing continues to 212.

At 212, the book is checked-in. When being checked-in, the association between the user the book can be removed. It will be appreciated that 202-212 can be repeated in whole or in part in order to accomplish a contemplated educational library management task.

FIG. 3 is an example computer server system 300 for educational library management in accordance with at least one embodiment. The server device 300 includes a processor 302, operating system 304, memory 306 and I/O interface 308. The memory 306 can include an educational library system application 310 and one or more book, library and/or member databases 312.

In operation, the processor 302 may execute the application 312 stored in the memory 306. The application 312 can include software instructions that, when executed by the processor, cause the processor to perform operations for educational library management in accordance with the present disclosure (e.g., performing one or more of steps 202-212 described above and/or any of the additional features described herein).

The application program 312 can operate in conjunction with the book, library and/or member databases 312 and the operating system 304.

FIG. 4 is a diagram of an example book record 400 in accordance with at least one embodiment. The book record 400 can include a title field 402, an identification (ID) field 404, bibliographic information 406, and leveling information 408 from one or more sources.

In addition to the above-mentioned fields, the record 400 can optionally include one or more user definable fields. These user definable fields are customized and editable fields.

Some implementations can include an option for users to select from a menu of pre-built categories with either free-form entry or standard fill options. In addition, can add their own categories and fill formats (e.g., user definable fields). This customization can allow users to create a custom database environment.

FIG. 5 is a diagram of an example member record 500 in accordance with at least one embodiment. The member record 500 can include member name 502, member ID 504, biographic information 506, optional reading level 508 and one or more user definable fields 510 (similar to 410 described above). Also, the member record can include a history of books checked out and checked in.

FIG. 6 is a diagram of an example leveling translation system in accordance with at least one embodiment. The educational library system 102 can receive leveling information from one or more leveling information sources (602-606). An input leveling value 608, in a first leveling scheme, can be received by the system 102. The educational library system 102 can translate the input leveling value 608 into a translated leveling value 610 in a second leveling scheme, different from the first.

FIG. 7 is an example method for leveling and labeling a book in accordance with at least one embodiment. Processing begins at 702, where a scan of a book (e.g., barcode, ISBN or other portion of book cover) is received. Processing continues to 704.

At 704, the scan is decoded and one or more levels for the book are determined. For example, once the scan is decoded (e.g., an ISBN or EAN is resolved) the system can retrieve one or more levels from the database. Processing continues to 706.

At 706, a label for the book is generated, where the label can include leveling information determined in 704.

Some implementations can include an ability to track lending history statistics, report these to a third party so the third party can track cumulative traffic on popular titles. This report can be published as a “Hot List” so that other librarians can keep up with which titles are most popular around the country. Also the system can generate statistics telling which classroom is reading the most and offer regular contests with rewards.

The system can also offer librarians an opportunity to either make purchases directly through a web store associated with the system or create a Wish List of books that they would like to eventually add to their libraries.

Each library can be “publishable” to a third party web site so that the shelves can be “virtually” browsed by teachers, students, and their parents. Visible Wish Lists would be included and offer easy suggestions to parents or others wishing to donate or make gifts to individual libraries. The system can offer the convenience of being able to make a purchase directly through the third party web store, which is automatically added to a library.

The system can provide direct links for books in the database to the third party web store to purchase either that title and/or other suggested titles that are related to that book. Every purchase can be designated to a new or existing library so that all of the book data is pre-loaded and available by the time the books physically arrive.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering, reading education and library science arts.

Moreover, embodiments of the disclosed method, system, and computer readable media (or computer program product) can be implemented in software executed on a programmed general purpose computer, a special purpose computer, a microprocessor, or the like.

It is, therefore, apparent that there is provided, in accordance with the various embodiments disclosed herein, methods, systems and computer readable media for educational library management.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A method for managing an educational library, the method comprising:
generating a book database having a plurality of book records, each book record including a unique identifier and leveling information;
creating a librarian account and at least one library associated with the librarian account;
adding one or more books to the at least one library, each book being associated with a library book record, the adding including scanning a book with a mobile device configured to perform the method and retrieving data from the book database based on the scanning;
receiving a list of one or more members;
checking out a book to a member; and
checking in a book from a member.

2. The method of claim 1, further including:
receiving a desired level in a first leveling scheme;
translating the desired level into a translated level in a second leveling scheme; and
retrieving a list of books based on the translated level.

3. The method of claim 1, wherein the library book record includes one or more user definable fields.

4. The method of claim 1, further comprising generating a barcode label having the unique identifier encoded therein and generating a leveling label having the leveling information displayed thereon.

5. The method of claim 1, wherein the at least one library includes a first library and a second library different from the first.

6. The method of claim 1, wherein the at least one library associated with the librarian account is configured to lend books to another library associated with a different librarian account.

7. The method of claim 1, further comprising exporting a file listing one or more of libraries, books and members associated with the librarian account.

8. A method comprising:
receiving a scan of a portion of a book;
decoding the scan to determine an identifier for the book;
determining leveling information for the book by looking up the book in a leveling database using the identifier; and
generating a label for the book, wherein the label includes the leveling information.
